(19) United States
(12) Patent Application Publication
(10) Pub. No.: US 2005/0238835 A1
(43) Pub. Date: Oct. 27, 2005

(54) Graphite composite thermal sealants and associated methods

(76) Inventor: Chien-Min Sung, Tansui (TW)

Correspondence Address: M. Wayne Western;THORPE NORTH & WESTERN, LLP, P.O. Box 1219, Sandy, UT, 84091-1219, US

(21) Appl. No.: 10/887,217

(22) Filed: Jul. 7, 2004

Related U.S. Application Data
(60) Provisional application No. 60/565,218, filed on Apr. 24, 2004.

(51) Int. Cl. B32B 9/00

(52) U.S. Cl. 428/40.1

(57) ABSTRACT

A graphite composite thermal sealant having a graphite matrix and a metal is disclosed and described. The metal can be dispersed in the graphite matrix or provided in a separate layer. Graphite having a high degree of graphitization can be of particular benefit. Further, the metal can be a soft metal such as In, Ag, Cu, Pb, Zn, Sn, Au, or alloys of these metals. The thermal sealant materials described herein can have thermal conductivities in excess of about 200 W/mK, while also minimizing or eliminating voids or pores between sealed surfaces.

### CLAIM OF PRIORITY

This application claims priority to U.S. Provisional Patent Application No. 60/565,218, filed on Apr. 24, 2004, which is incorporated by reference herein in its entirety.

### FIELD OF THE INVENTION

The present invention relates to sealants and materials that can be used as an interface material which conducts heat away from a heat source. Accordingly, the present invention involves the fields of materials science, chemistry, physics, and semiconductor technology.

### BACKGROUND OF THE INVENTION

Progress in the semiconductor industry has been following the trend of Moore's Law that was proposed in 1965 by then Intel's cofounder Gordon Moore. This trend requires that the capability of integrated circuits (IC) or, in general, semiconductor chips double every 18 months. Along with such advances comes various design challenges. One of the often overlooked challenges is that of heat dissipation. Most often, this phase of design is neglected or added as a last minute design before the components are produced. According to the second law of thermodynamics, the more work that is performed in a closed system, the higher entropy it will attain. With the increasing power of a CPU, the larger flow of electrons produces a greater amount of heat. Therefore, in order to prevent the circuitry from shorting or burning out, the heat resulting from the increase in entropy must be removed. Some state-of-the-art CPUs have a power of about 60 watts (W). For example, a CPU made with 0.13 micrometer technology may exceed 100 watts. Moreover, when temperatures reach more than 90° C., the semiconductor portion of the chip may become a conductor so the function of the chip is lost. In addition, the circuitry may be damaged and the semiconductor is no longer usable (i.e. becomes “burned out”). Thus, in order to maintain the performance of the semiconductor, its temperature must be kept below a threshold level (e.g., 90° C.

Current methods of heat dissipation, include a wide variety of devices and materials such as metal (e.g., Al or Cu) fin radiators, water evaporation heat pipes, ceramic heat spreaders, diamond-containing heat spreaders, and the like. Typically, these heat dissipation devices can have very high thermal conductivities and many excellent designs and materials are available. However, most of these devices are attached to a heat source using thermal interface materials having significantly lower thermal conductivity and heat dissipation properties than the attached device. For example, standard thermal interface materials can include thermal greases, thermal wax, thermal tape, gap pads, and the like. Additionally, most semiconductor devices can be damaged by temperatures required for brazing of surfaces. Thermal greases and waxes can have the benefit of improved ability to prevent voids or gas pockets. Such voids have a very high thermal resistance. However, thermal tapes, gap pads and other solid thermal interface materials tend to have higher thermal conductivities. Existing thermal interface materials continue to be one of the major factors in preventing further improvements in heat dissipation.

Typical thermal greases have a thermal conductivity of less than about 20 W/mK, and often less than about 10 W/mK. In contrast, standard heat spreaders and heat sinks have a thermal conductivity above about 200-300 W/mK. Table 1 illustrates representative thermal properties of several materials associated with removal of heat from common heat sources.

TABLE 1

| | Thermal | | Thermal |
|---|---|---|---|
| | Conductivity | Heat Capacity | Expansion |
| Material | (W/mK) | (J/cm³ K) | (ppm/K) |
| Copper | 401 | 3.44 | 16.4 |
| Aluminum | 237 | 2.44 | 24.5 |
| Molybdenum | 138 | 2.57 | 47.5 |
| Gold | 317 | 2.49 | 14.5 |
| Silver | 429 | 2.47 | 18.7 |
| Silicon | 148 | 1.66 | 2.6 |
| Diamond (IIa) | 2,300 | 1.78 | 1.4 |

As a result, the thermal interface material acts as a bottleneck which reduces the value of any improvements in the attached heat dissipation devices. As such, thermal sealants and associated materials that are capable of effectively sealing gaps between surfaces in order to efficiently conduct heat away from a heat source continue to be sought.

### SUMMARY OF THE INVENTION

Accordingly, the present invention provides a graphite thermal sealant material, comprising a consolidated graphite matrix and a metal. In one aspect, the graphite matrix includes graphite having a high degree of graphitization. In some embodiments, the degree of graphitization can be greater than 0.90, and in additional embodiments can be greater than 0.95.

In accordance with an aspect of the present invention, the metal can be a member selected from the group consisting of In, Ag, Cu, Pb, Zn, Sn, Au, and alloys thereof. One currently preferred metal is In.

In another aspect of the present invention, the metal can be a soft metal having a Moh's hardness less than 4.

In yet another aspect, the thermal sealant material can have a total thickness from about 0.5 μm to about 100 μm.

Commercial embodiments of the thermal sealant material can also include a removable backing. Additionally, the thermal sealant material can be formed as a tape or in discrete segments.

The thermal sealants of the present invention can be provided in a number of configurations. In one aspect, the graphite matrix can include the metal dispersed therein. In such embodiments, graphite can comprise from about 10 vol % to about 90 vol % of the material, and preferably from about 40 vol % to about 60 vol % of the material.

In an alternative aspect of the present invention, the metal can be provided in a metal layer adjacent to the graphite matrix.

In yet another alternative aspect, a second graphite matrix can be adjacent the metal layer opposite the graphite matrix. In this aspect, each of the graphite matrix and second graphite matrix can have a thickness from about 10 μm to about 50 μm.

In still another alternative aspect, the thermal sealant material can further include a second metal layer adjacent the graphite matrix opposite the metal layer. Optionally, the metal layer can have a different composition than the second metal layer. In a related aspect, the metal layer and second metal layer can comprise a metal independently selected from the group consisting of Au, Ag, Cu, and alloys thereof.

In another aspect of the present invention, the thermal conductivity of the material is from about 100 W/mK to about 450 W/mK.

In another detailed aspect, the graphite matrix can further comprise nanoparticles. In this aspect, the nanoparticles can comprise a member selected from the group consisting of nanodiamond, cubic boron nitride, silicon carbide, and mixtures thereof. Further, the nanoparticles can comprise from 2 vol % to about 20 vol % of the graphite matrix.

In accordance with one aspect of the present invention, a sealant kit for coupling two surfaces can comprise a thermal sealant material as disclosed herein and having a thermal conductivity greater than about 200 W/mK and a removable backing adjacent the thermal sealant material.

In a detailed alternative embodiment, a thermal sealant can comprise a metal layer and a molybdenum disulfide layer adjacent thereto.

A method of sealing two surfaces can comprise providing a first surface. A thermal sealant material can be placed adjacent the first surface. Further, a second surface can be placed adjacent the thermal sealant opposite the first surface.

In a detailed aspect of the above method, at least one of the first and second surfaces can be heated sufficient to soften at least a portion of the thermal sealant material.

In another detailed aspect, the thermal sealant material can be shaped to fit within contact areas between the first and second surfaces.

Further, the first and second surfaces can be independently selected from the group consisting of CPU, heat spreader, and heat sink.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### BRIEF DESCRIPTION OF THE DRAWINGS

FIG. 1 is a side cross-sectional view of a thermal sealant material having an optional removal backing in accordance with an embodiment of the present invention;

FIG. 2 is a side cross-sectional view of a thermal sealant material having a graphite matrix and two metal layers in accordance with an embodiment of the present invention; and

FIG. 3 is a side cross-sectional view of a thermal sealant material having a metal layer and two graphite matrix layers in accordance with an embodiment of the present invention.

It will be understood that the above figures are merely for illustrative purposes in furthering an understanding of the invention. For example, the figures are not drawn to scale, thus dimensions and other aspects may, and generally are, exaggerated to make illustrations thereof clearer. Therefore, departure can be made from the specific dimensions and aspects shown in the figures in order to produce thermal sealants within the scope of the present invention.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an” and, “the” include plural referents unless the context clearly dictates otherwise. Thus, for example, reference to “a metal layer” includes one or more of such layers and reference to “the discrete segment” includes reference to one or more of such segments.

Definitions

In describing and claiming the present invention, the following terminology will be used in accordance with the definitions set forth below.

As used herein, “heat source” refers to a device or object having an amount of thermal energy or heat which is greater than desired. Heat sources can include devices that produce heat as a byproduct of their operation, as well as objects that become heated to a temperature that is higher than desired by a transfer of heat thereto from another heat source.

As used herein, “consolidated” and “consolidation” refer to forming a coherent solid mass from smaller constituents. Consolidation can be accomplished by any number of techniques such as pressing, sintering, brazing, infiltration, and the like. Typically, pressing can include low pressure pressing, cold or hot isostatic pressing, or other processes which involve mechanical interlocking of particles without substantial sintering.

As used herein, “sintering” refers to the joining of two or more individual particles to form a continuous solid mass. In one aspect, sintering can involve at least partial elimination of voids between particles. Sintering may occur in either metal or carbonaceous particles, i.e. carbon, graphite, diamond, etc. Sintering of metal particles occurs at various temperatures and pressures depending on the composition of the material.

As used herein, “degree of graphitization” refers to the proportion of graphite which has graphene planes having a theoretical spacing of 3.354 angstroms. Thus, a degree of graphitization of 1 indicates that 100% of the graphite has a basal plane separation (d₍₀₀₀₂₎) of graphene planes, i.e. with hexagonal network of carbon atoms, of 3.354 angstroms. A higher degree of graphitization indicates smaller spacing of graphene planes. The degree of graphitization, G, can be calculated using Equation 1.
G=(3.440−d₍₀₀₀₂₎)/(3.440−3.354) (1)
Conversely, d₍₀₀₀₂₎ can be calculated based on G using Equation 2.
d₍₀₀₀₂₎=3.354+0.086(1−G) (2)
Referring to Equation 1, 3.440 angstroms is the spacing of basal planes for amorphous carbon (L_{c}=50 Å), while 3.354 angstroms is the spacing of pure graphite (L_{c}=1000 Å) that may be achievable by sintering graphitizable carbon at 3000° C. for extended periods of time, e.g., 12 hours. A higher degree of graphitization corresponds to larger crystallite sizes, which are characterized by the size of the basal planes (Lₐ) and size of stacking layers (L_{c}). Note that the size parameters are inversely related to the spacing of basal planes.

Graphite is available in a wide variety of grades and forms such as amorphous, crystalline, and synthetic graphite. Table 2 shows crystallite properties for several common grades of graphite.

TABLE 2

| Graphite Type | d₍₀₀₂₎ | Lₐ (Å) | L_{c} (Å) | I₁₁₂/I₁₁₀ |
|---|---|---|---|---|
| Pure Natural | 3.355 | 1250 | 375 | 1.3 |
| Low Temp (2800° C.) | 3.359 | 645 | 227 | 1.0 |
| Electrode | 3.360 | 509 | 184 | 1.0 |
| Spectroscopic | 3.362 | 475 | 145 | 0.6 |
| High Temp (3000° C.) | 3.368 | | 400 | 0.9 |
| Low Ash | 3.380 | 601 | 180 | 0.8 |
| Poor Natural | 3.43 | 98 | 44 | 0.5 |

Further, Table 3 illustrates the anisotropic properties of graphite.

TABLE 3

| | Thermal Conductivity | Thermal Expansion |
|---|---|---|
| Graphite anisotropy | (W/mK) | (ppm/K) |
| // to basal planes | 1950 | 0.5 |
| ⊥ to basal planes | 5.7 | 27 |

As used herein, “nanoparticle” refers to particles having an average particle size in the nanometer range, i.e. less than about 500 nm, and typically less than about 100 nm. Nanoparticles can be formed directly using various known synthesis techniques or by crushing larger particles.

As used herein, “nanodiamond” refers to carbonaceous particles having crystal sizes in the nanometer range, i.e. about 1 nm to about 20 nm. Nanodiamond particles can also have nanometer range crystalline formations, e.g., about 1 nm to about 10 nm. Further, nanodiamond is intended to refer to particles having nanometer scale crystal structure. Nanodiamond particles can be formed using a number of known techniques. One nanodiamond formation technique involves the explosion of dynamite or other explosives to produce nanodiamond having nanocrystalline structure and has particle sizes in the range of from about 2 to about 10 nm. Typical fine diamond particles have a particle size larger than about 0.1 μm. These diamond particles are most commonly produced by pulverizing larger diamond particles. This pulverization process results in particles having irregular shapes and sharp corners. Additionally, some diamond particles can be pulverized to form particles in the nanometer size range. However, these pulverized diamond particles are often not suitable for polishing materials which require a mirror finish and very low surface roughness, i.e. in the angstrom range. Further, diamond is significantly harder than most other common abrasives. For example, diamond typically has a Moh's hardness (original scale) of about 10 or greater. Further, all references to a Moh's hardness are with respect to the original, not modified, Moh's scale.

As used herein with respect to an identified property or circumstance, “substantially” refers to a degree of deviation that is sufficiently small so as to not measurably detract from the identified property or circumstance. The exact degree of deviation allowable may in some cases depend on the specific context. Thus, for example, a metal which has a composition “substantially” that of a second metal layer may deviate in composition or relevant property, e.g., thermal conductivity, hardness, etc., by experimental error up to several percent, e.g., 1% to 3%.

Concentrations, amounts, particle sizes, volumes, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

The Invention

The present invention encompasses materials and methods for sealing surfaces with improved heat transfer properties. The thermal sealant materials of the present invention can provide an effective medium to more fully utilize the heat removal capacities of known and to be developed thermal management systems such as heat spreaders and heat sink devices. Thermal sealant materials made in accordance with the method of the present invention generally contain a consolidated graphite matrix and a metal.

The consolidated graphite matrix can be provided in a number of configurations and specific compositions. Typically, the graphite matrix can include graphite having particular properties. Suitable graphite for use in the present invention can include, without limitation, pure natural graphite, low temperature graphite, electrode graphite, spectroscopic graphite, high temperature graphite, and mixtures thereof. In one aspect the graphite can be pure natural graphite. As a useful guideline, the graphite can have a high degree of graphitization, i.e. greater than about 0.80. In one detailed aspect, the degree of graphitization can be greater than 0.90, and in a preferred aspect the degree of graphitization can be greater than 0.95.

As highlighted in Table 3, the thermal properties of graphite can vary greatly depending on the orientation of graphitic planes. For example, thermal conductivity measured perpendicular to graphitic planes is about 5.7 W/mK, while thermal conductivity measured parallel to graphitic planes is about 1950 W/mK. A layer of graphite matrix having about 100 vol % graphite can have a tendency to align graphitic planes parallel to one another along an interface surface. Thus, in some embodiments, it can be preferable to incorporate materials which disrupt the alignment of graphitic planes, as discussed in more detail below in connection with several alternative embodiments. In addition, the thermal expansion coefficient of graphite is exceptionally low along the direction of the basal planes. The low thermal expansion of graphite can make joining it with low thermally expanding silicon semiconductors much easier. Hence, the stress at the joining interface can be minimized.

The consolidated graphite matrix can be formed using a variety of known processes. For example, the graphite matrix can be formed by pressing powdered graphite in a conventional press. In some cases, a suitable consolidated graphite matrix can be formed under an applied pressure of from about 100 MPa to about 300 MPa, in some cases from about 100 MPa to about 250 MPa, and preferably from about 120 MPa to about 150 MPa. Alternatively, graphite powder can be sprayed onto a moving substrate. The graphite coated substrate can then be rolled to form a coherent material.

In accordance with the present invention, a metal can be included within the graphite matrix or as a separate layer or layers. Typically, the metal can be incorporated into the thermal sealant in order to provide a soft material. When included within the graphite matrix, the soft metal can reduce the order of the graphite and therefore create more isotropic thermal properties. In some cases, the thermal properties of such a mixture can approach or exceed that of copper. Additionally, in all embodiments of the present invention, the soft metal can improve the ability of the thermal sealant to fill in gaps and pores between joined surfaces. In one detailed aspect, the soft metal can have a Moh's hardness less than 4. In a further aspect, the soft metal can have a Moh's hardness of less than about 3, and most preferably less than about 2. A wide variety of soft metals and alloys satisfy this criteria. Non-limiting examples of several suitable soft metals include In, Ag, Cu, Pb, Zn, Sn, Au, and alloys thereof. One currently preferred soft metal is indium.

Further, the metal can be provided as a fine particulate powder. The metal powder can have an average particle size from about 5 nm to about 10 μm and preferably from about 8 nm to about 500 nm and most preferably from about 10 nm to about 100 nm, although sizes outside these ranges can also be used.

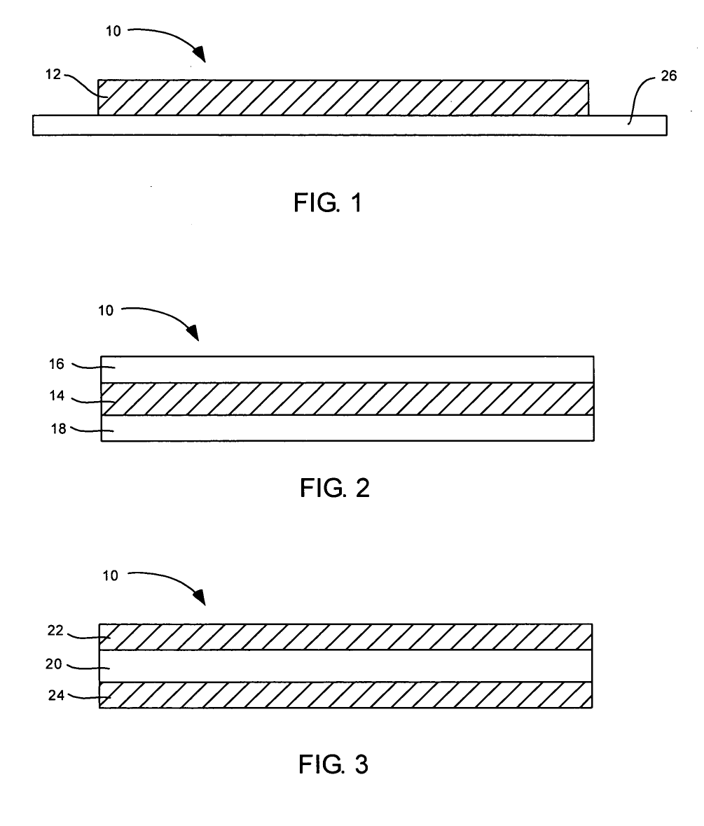

Referring now to FIG. 1, a graphite thermal sealant 10 is shown in accordance with an embodiment of the present invention. In one aspect, a graphite matrix 12 can include a mixture of graphite with the metal dispersed therein. Typically, the graphite matrix can comprise from about 10 vol % to about 90 vol % graphite. In one specific embodiment, the graphite matrix can comprise from about 40 vol % to about 60 vol % of the material. The metal can be any metal discussed above. However, in embodiments having the metal dispersed in the graphite matrix, the metal can preferably be Zn, Sn, Pb, and alloys thereof. In one specific embodiment, the metal can be an ultrafine zinc powder.

Referring to FIG. 2, a graphite thermal sealant is shown generally at 10 in accordance with an alternative embodiment of the present invention. A graphite matrix 14 can be adjacent at least one metal layer 16. FIG. 2 illustrates an embodiment including a second metal layer 18 adjacent the graphite matrix opposite the metal layer. In one aspect of the present invention, the second metal layer 18 can have substantially the same composition as the metal layer 16. However, in some cases it can be desirable to design the thermal sealant material to have differing compositions of metal layers placed on each side of the graphite matrix. Further, the metal layers can be further coated with an additional metal layer. For example, an oxidation resistant metal such as gold or silver can be coated over more easily oxidized metals such as zinc or tin. In one detailed aspect, the metal layer and second metal layer can comprise a metal independently selected from the group consisting of Au, Ag, Cu, and alloys thereof. In another detailed aspect, the metal layer can comprise Au, Ag, or alloys of these metals.

In one aspect, at least one of the metal layers can comprise a material which has a relatively low melting point or softening point such that upon heating a respective surface to be joined, the metal layer softens and more intimately fills in gaps and pores in the surface. In particular, metals or alloys having a melting temperature below about 350° C. can be used, or in some cases having a melting temperature below about 250° C. However, it should be kept in mind that materials having a melting temperature near typical operating temperatures, i.e. within about 5° C., for a particular component can allow the material to soften and substantially fill in gaps, pores, and contours of a surface. Further, materials having melting temperatures substantially below typical operating temperatures can cause undesirable weakness, flow, and/or failure of the seal between surfaces. Typical semiconductor devices such as CPUs and the like have operating temperatures up to about 100° C. Therefore, as a general matter, suitable metals and metal alloys can have a melting temperature from about 95° C. to about 400° C. and in some cases 180° C. to about 350° C. or 250° C., depending on the particular application.

Typically, the metal layers can have a thickness which is from about 0.2 to about 4 times the thickness of the graphite matrix, and in some cases can be from about 0.5 to about 2 times, with about 1 times being most typical. Frequently, the metal layers can be provided as thin metal foils. Alternatively, the metal layers can be provided as a particulate which is then pressed or otherwise consolidated to form a coherent material adjacent the graphite matrix. In yet another alternative, the metal layers can be deposited via spraying, PVD, CVD, electrodeposition, or other similar processes known to those skilled in the art. Conveniently, in embodiments where the metal is provided in a distinct metal layer from the graphite matrix, the metal layer can be provided as a metal foil. Such metal foils can be consolidated from powders, rolled, and/or obtained directly from a wide variety of commercial sources as a foil.

Another alternative embodiment is shown in FIG. 3 which includes a metal layer 20 adjacent a first graphite matrix 22 and a second graphite matrix 24 adjacent the metal layer opposite the first graphite matrix. Typically, in such embodiments each of the first graphite matrix and second graphite matrix have a thickness from about 10 μm to about 50 μm.

Regardless of the particular embodiment, the graphite thermal sealant materials of the present invention can be formed in any of a number of useful shapes and configurations. Broadly, the thermal sealant material can have a thickness from about 0.1 μm to about 300 μm, depending on the surfaces to be joined. In one aspect, a desirable thickness can depend on the surface roughness of surfaces to be joined. For example, extremely low surface roughness, e.g., in the nanometer range, can utilize thinner thermal sealants, while higher surface roughness can necessitate slightly thicker thermal sealant layers. Additionally, surfaces having contours and/or features can benefit from thicker thermal sealant to avoid formation of voids. In many embodiments, the thermal sealants of the present invention can have a thickness from about 0.5 μm to about 100 μm, and preferably from about 20 μm to about 60 μm.

For typical commercial embodiments, it can be desirable to include a removable backing 26 adjacent at least one side of the thermal sealant material as shown in FIG. 1. Such backings are known to those skilled in the art and can comprise a material such as paper, plastic film or the like. Any suitable releasable adhesive can be included which does not leave substantial residue on the thermal sealant once removed therefrom. Such thermal sealants having a removable backing can be manufactured as a sealant kit for sealing two surfaces.

In accordance with the present invention the graphite thermal sealants can be formed into any number of configurations, based on an intended use. Frequently, the graphite thermal sealants can be provided as a continuous tape. The tape can be cut and shaped to conform to a particular application by an end used. Optionally, the thermal sealant material can be provided in discrete segments, generally corresponding to commonly used shapes. For example, the discrete segments can be rectangular, circular, or the like such that the discrete segment corresponds to an interface between two surfaces.

The specific properties of various embodiments of the present invention can vary; however, the thermal conductivity of the thermal sealant material can be from about 100 W/mK to about 450 W/mK. Preferably the thermal conductivity can exceed 200 W/mK, such as from about 250 W/mK to about 400 W/mK.

In yet another alternative embodiment, the graphite matrix can further comprise nanoparticles. Such nanoparticles can provide additional improvement in thermal conductivity by virtue of the nanoparticles material, as well as in increased disruption of ordered layering of graphitic planes. Suitable nanoparticles can include a wide variety of known nanoparticles. Particularly suitable nanoparticles can comprise nanodiamond, cubic boron nitride, silicon carbide, and mixtures of these particles. When nanoparticles are used, the nanoparticles can comprise from 2 vol % to about 20 vol % of the graphite matrix. In one detailed aspect, the nanoparticles can comprise from about 5 vol % to about 15 vol %, and in one embodiment about 10 vol % of the graphite matrix. The nanoparticles can be incorporated by mixing with graphite powder prior to consolidation into the graphite matrix.

In yet another alternative embodiment, the present invention can additionally encompass a thermal sealant comprising a metal layer as discussed above and a molybdenum disulfide layer adjacent thereto. Typically, the molybdenum disulfide layer can be coated on a metal foil layer by pressing, rolling, or deposition, e.g., CVD, PVD, electrodeposition, etc., directly on the metal layer.

Once the thermal sealant is formed in accordance with the present invention, appropriate use can be based on design and heat transfer principles. More specifically, a method of sealing two surfaces can include placing the thermal sealant material of the present invention adjacent a first surface. A second surface can then be placed adjacent the thermal sealant opposite the first surface. The two surfaces can be pressed together to form a seal which is substantially free of voids or gaps. In one aspect of the present invention, the thermal sealant can form an acceptable seal by firmly pressing the surfaces together. In many cases, the seal can be improved when the surfaces are exposed to normal operating temperatures. For example, as a heat source is operated under normal conditions, the thermal sealant is heated and can be softened, depending on the specific choices of materials. In another aspect, one or both of the surfaces can be heated prior to, after, or during sealing of the two surfaces. In this case, at least one of the first and second surfaces can be heated sufficient to soften at least a portion of the thermal sealant material. In embodiments where the graphite matrix is layered on two sides with metal layers of differing compositions (such as in FIG. 2), the metal layer having an appropriate melting or softening temperature can be placed in contact with the heated surface. Advantageously, the thermal sealant materials of the present invention can be used to seal surfaces at relatively low temperatures and pressures. Typically, temperatures less than about 400° C. and pressures less than about 5 MPa, and preferably less than about 0.5 MPa, can achieve a thorough seal across the interface between surfaces having substantially no gaps or voids therein.

The thermal sealant materials of the present invention can be used to seal a wide variety of surfaces. Some of the most common suitable surfaces can include CPUs, heat spreaders, and heat sinks. Other suitable surfaces which can be joined using the thermal sealants of the present invention can include, without limitation, semiconductor devices, laser diodes, microwave generators, and the like. For example, a semiconductor chip or CPU can be efficiently cooled by sealing a heat spreader thereto using the thermal sealant material of the present invention. Additionally, a heat sink can then be sealed to the heat spreader in a similar manner.

The following example presents one embodiment for making the thermal sealants of the present invention. As such, the example is illustrative only, and no limitation on the present invention is meant thereby.

### EXAMPLE

Graphite powder having a high degree of graphitization was secured from Morgan Specialty Graphite (purified natural graphite). A mold having an adjustable recess depth is provided. The mold has a 50 mm diameter and is adjusted to a 0.1 mm depth which is filled with the graphite powder. The bottom of the mold is then adjusted an additional 0.2 mm in depth (total 0.3 mm). An undersized 0.1 mm thick indium disk is placed on the graphite powder followed by filling the remaining space with additional graphite powder. The powder assembly is then placed in a high pressure apparatus and pressed to about 250 MPa. During pressing, the temperature of the assembly is raised to about 100° C., which is sufficient to cause adherence of the graphite to the indium disk and at least partial consolidation of the graphite powder. Indium has a melting temperature of about 156.6° C. and may oxidize slowly in the presence of air. The pressing process can be performed in a non-oxidizing atmosphere; however, the presence of graphite can inhibit oxidation of the indium by air sufficiently to avoid using non-oxidizing atmospheres such as nitrogen or argon. The final thermal sealant material is pushed out of the mold and has a pressed thickness of less than about 0.2 mm.

Of course, it is to be understood that the above-described arrangements are only illustrative of the application of the principles of the present invention. Numerous modifications and alternative arrangements may be devised by those skilled in the art without departing from the spirit and scope of the present invention and the future appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

1. A graphite thermal sealant material, comprising:
a) a consolidated graphite matrix; and
b) a metal.

2. The material of claim 1, wherein said graphite matrix includes graphite having a high degree of graphitization.

3. The material of claim 2, wherein the degree of graphitization is greater than 0.90.

4. The material of claim 3, wherein the degree of graphitization is greater than 0.95.

5. The material of claim 1, wherein the metal is a member selected from the group consisting of In, Ag, Cu, Pb, Zn, Sn, Au, and alloys thereof.

6. The material of claim 5, wherein the metal is In.

7. The material of claim 1, wherein the metal is a soft metal having a Moh's hardness less than 4.

8. The material of claim 1, wherein the material has a thickness from about 0.5 μm to about 100 μm.

9. The material of claim 1, further comprising a removable backing.

10. The material of claim 9, wherein the material is formed as a tape.

11. The material of claim 9, wherein the material is formed in discrete segments.

12. The material of claim 1, wherein said graphite matrix further includes the metal dispersed therein.

13. The material of claim 12, wherein said graphite matrix includes graphite which comprises from about 10 vol % to about 90 vol % of the material.

14. The material of claim 13, wherein said graphite matrix includes graphite which comprises from about 40 vol % to about 60 vol % of the material.

15. The material of claim 12, wherein the metal is provided in a metal layer adjacent to the graphite matrix.

16. The material of claim 15, further comprising a second graphite matrix adjacent the metal layer opposite the graphite matrix.

17. The material of claim 16, wherein each of the graphite matrix and second graphite matrix have a thickness from about 10 μm to about 50 μm.

18. The material of claim 15, further comprising a second metal layer adjacent the graphite matrix opposite the metal layer.

19. The material of claim 18, wherein the metal layer has a different composition than the second metal layer.

20. The material of claim 18, wherein the metal layer and second metal layer comprise a metal independently selected from the group consisting of Au, Ag, Cu, and alloys thereof.

21. The material of claim 1, wherein the thermal conductivity of the material is from about 100 W/mK to about 450 W/mK.

22. The material of claim 1, wherein the graphite matrix further comprises nanoparticles.

23. The material of claim 20, wherein the nanoparticles comprise a member selected from the group consisting of nanodiamond, cubic boron nitride, silicon carbide, and mixtures thereof.

24. The material of claim 20, wherein the nanoparticles comprise from 2 vol % to about 20 vol % of the graphite matrix.

25. A sealant kit for coupling two surfaces, comprising:
a) a material as in any of claims 1, 12, 15, and 22 having a thermal conductivity greater than about 200 W/mK; and
b) a removable backing adjacent the material.

26. A thermal sealant comprising a metal layer and a molybdenum disulfide layer adjacent thereto.

27. A method of sealing two surfaces, comprising the steps of:
a) providing a first surface;
b) placing a thermal sealant material as in any of claims 1, 12, 15, and 22 adjacent the first surface; and
c) placing a second surface adjacent the thermal sealant opposite the first surface.

28. The method of claim 27, further comprising the step of heating at least one of the first and second surfaces sufficient to soften at least a portion of the thermal sealant material.

29. The method of claim 27, further comprising the step of shaping the thermal sealant material to fit within contact areas between the first and second surfaces.

30. The method of claim 27, wherein the first and second surfaces are independently selected from the group consisting of CPU, heat spreader, and heat sink.
